(19) United States
(12) Patent Application Publication
(10) Pub. No.: US 2023/0022899 A1
(43) Pub. Date: Jan. 26, 2023

(54) METHODS OF HANDLING ONE OR MORE VESSELS AND/OR EQUIPMENT IN A TERMINAL, AND RELATED DEVICES AND SYSTEMS

(71) Applicant: A.P. MØLLER - MÆRSK A/S, Copenhagen K (DK)

(72) Inventors: Hugo MEUNIER, Le Cannet (FR); Stefan Otto Theodor GUERICKE, Kongens Lyngby (DK)

(21) Appl. No.: 17/783,673

(22) PCT Filed: Dec. 17, 2020
(86) PCT No.: PCT/EP2020/086790

§ 371 Date: Jun. 9, 2022

(30) Foreign Application Priority Data
Dec. 20, 2019 (DK) PA201901566

(51) Int. Cl. G06Q 10/08; G06Q 10/04

(52) U.S. Cl. CPC G06Q 10/08; G06Q 10/04

(57) ABSTRACT

A method of handling one or more vessels and/or equipment in a terminal is disclosed. The method comprises obtaining an initial Berth plan comprising vessel data of a set of vessels. The method comprises determining a first Berth plan based on the initial Berth plan. The method comprises determining if the first Berth plan satisfies a first criterion. The method comprises in accordance with a determination that the first Berth plan satisfies the first criterion, updating a Berth plan set with the first Berth plan. The method comprises outputting the Berth plan set to a control system.

The present disclosure pertains to the field of transport and freight. The present disclosure relates to methods of handling one or more vessels and/or equipment in a terminal, and related devices and systems.

### BACKGROUND

Berth plan scheduling is the process to create Berth plans for a pool of vessels calling a terminal, considering physical and delivery constraints and a fixed amount of resources (piers, cranes, workforce).

Berth plans are often outdated and disrupted due to the occurrence of unforeseen and unpredictable events (e.g. late vessels, terminal delay). A considerable amount of time is dedicated to update Berth plans by hand and usually all potential solutions aren't explored, which can lead to poor productivity. Classical approaches cannot easily consider trade-offs between carrier and terminal perspective for a large pool of vessels.

### SUMMARY

Accordingly, there is a need for methods of handling one or more vessels and/or equipment in a terminal, and related devices and systems which mitigate, alleviate or address the shortcomings existing and jointly optimise carrier and terminal performance to provide Berth plans.

A method of handling one or more vessels and/or equipment in a terminal is disclosed. The method comprises obtaining an initial Berth plan comprising vessel data of a set of vessels. The method comprises determining a first Berth plan based on the initial Berth plan. The method comprises determining if the first Berth plan satisfies a first criterion. The method comprises in accordance with a determination that the first Berth plan satisfies the first criterion, updating a Berth plan set with the first Berth plan. The method comprises outputting the Berth plan set to a control system.

Further, the present disclosure provides an electronic device comprising a memory circuitry, a processor circuitry, and an interface. The electronic device is configured to perform any of the methods disclosed herein.

The present disclosure provides a terminal control system comprising a memory circuitry, a processor circuitry, and an interface. The terminal control system is configured to receive a Berth plan set comprising a plurality of Berth plans, select a current Berth plan from the Berth plan set; and control the vessel and/or the equipment based on the current Berth plan.

The present disclosure provides a carrier control system comprising a memory circuitry, a processor circuitry, and an interface. The carrier control system is configured to receive a current first Berth plan from a terminal control system; and control one or more vessels based on the current first Berth plan.

It is an advantage of the present disclosure that a Berth plan set is generated based on considering multiple, potentially conflicting, objectives, both from the carriers' and terminal perspective. In other words, the present disclosure allows to provide a Berth plan set which optimizes carrier performance and terminal performance. This in turn may result in reduced delay of vessels between ports, and reduced petrol consumption of vessels. This may also lead to an improved crane utilization. The present disclosure also provides, in one or more example embodiments, an enhanced planning tool, such as a faster planning, which in turn allows a more efficient transhipment. Also, the present disclosure may lead, in one or more embodiment, to an improved communication and collaboration between carriers and terminals in identifying a Berth plan,

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating an exemplary system according to this disclosure,

FIGS. 2A-B are a flow-charts illustrating an exemplary method of handling one or more vessels and/or equipment in a terminal according to the disclosure,

FIG. 3 is a block diagram illustrating an exemplary electronic device according to this disclosure,

FIG. 4 is a block diagram illustrating an exemplary terminal control system according to this disclosure,

FIG. 5 is a block diagram illustrating an exemplary carrier control system according to this disclosure, and

FIG. 6 is an illustration of an exemplary method according this disclosure presented as scheme.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A Berth plan ensures that each vessel calling a terminal has a dedicated time slot and Berth area, such as with a defined number of quay cranes. A Berth plan is the output of a huge number of iterations in a complicated environment. It involves different fields of expertise held by different companies.

A vessel may comprise a vehicle, e.g. a ship. In one or more embodiments, a vessel comprises an airplane and a berth plan is seen as a plan to assign the loading and/or unloading equipment to the vessel. In one or more embodiments, a vessel comprises a terrestrial vehicle.

A Berth plan may be seen the output of the Berth scheduling. The main idea is to Berth and process a pool of vessels arriving over time in a terminal. A Berth plan represents a schedule for one or more vessels calling a terminal (e.g. the one or more vessels having the terminal as the next stop) considering various constraints. Information contained in a Berth plan can be different of each other due to the amount of available data associated with the one or more vessels and the considered constraints.

A Berth plan may comprise vessel data, such as one or more attributes associated with a corresponding vessel, such as an estimated time of arrival, an estimated time of departure, an information of its Berth position given by the identification of a bollard. For example, the Berth position may define where the vessel is to be moored on the quay. A Berth plan may comprise a vessel information regarding its quay crane assignment. Its quay crane assignment ensures enough quay cranes are available to unload and/or load items (e.g. discharge and load containers, and/or discharge and load of non-containerised goods) between the estimated time of arrival and departure of a vessel.

A quay crane assignment may have different level of precision regarding the amount of available information and how far in advance the Berth plan is scheduled. For example, it can be divided into three levels. For example, a first level may relate to a short-term scheduling (e.g. vessels arriving from day +1 to day +7) where for example for each vessel, the quay crane assignment provides, hour by hour, from its arrival to departure time, which quay cranes (e.g. identification of the quay crane) is planned to process the vessel at which position (e.g. identification of a bollard). For example, in the first level, the Berth plan ensures that no overtaking takes place (e.g. all quay cranes are moving along the same rail, e.g. no crane is allowed to overtake another crane).

For example, a second level may relate to a mid-term scheduling (e.g. vessels arriving from day +8 to day +14) where for each vessel, the quay crane assignment provides, shift by shift (e.g. an 8 hours' time period) or hour by hour, from its arrival to departure time, how many quay cranes process the vessel. The Berth plan doesn't ensure the no-overtaking constraints. For example, in the second level, the Berth plan ensures that the required number of quay cranes to process the vessel are available and that the quay cranes can all reach the vessel (e.g. a quay crane can only move on a limited range of the rail).

For example, a third level may relate to a long-term scheduling (e.g. vessels arriving from day +15 to day +21) where for each vessel, the quay crane assignment ensures, shift by shift, from its arrival to departure time, the required number of quay cranes to process the vessel are available. For example, in the third level, the Berth plan doesn't ensure the no-overtaking constraints.

In one or more example embodiments, a Berth plan comprises estimated time of arrival, the estimated time of departure and the Berth position of a vessel, (such as in a long-term, mid-term and/or short-term scheduling).

Berth Allocation Problem (BAP) and the Quay Crane Assignment Problem (QCAP) are problems which share the same environment with slightly different key performance indicators (KPI) and performance constraints. There is a need for an optimisation tool for generating optimized Berth plans.

KPIs for marine and Berth planner and required constraints are dynamic and renders the task quite difficult.

Finally, Berth plans are often outdated and disrupted due to the occurrence of unforeseen and unpredictable events (late vessels, terminal delay). A considerable amount of time is dedicated to update Berth plans manually and usually it is not possible to explore all potential solutions within a reasonable time period, which can lead to poor productivity. Classical approaches cannot easily consider trade-offs between carrier and terminal perspective for a large pool of vessels. Besides, aligning a feasible and satisfactory Berth plan between carriers and terminals is a time-consuming task.

A possible approach to manage the container flow at a terminal is provided by a shared cloud-based planning tool for carriers and terminals which enables both parties to be aware of changes in real time and make adjustments in view of constraints from carriers, terminals, port authorities and nautical service providers like pilots, tugs and linesmen.

It may be appreciated that the present disclosure proposes a technique which provides Berth plans for a single terminal while considering multiple, potentially conflicting, objectives (e.g. constraints), both from the carriers' and terminal perspective. In other words, the disclosed technique is based on a multi-objective optimisation that can be run on an hourly basis with updated values.

The figures are schematic and simplified for clarity, and they merely show details which aid understanding the disclosure, while other details have been left out. Throughout, the same reference numerals are used for identical or corresponding parts.

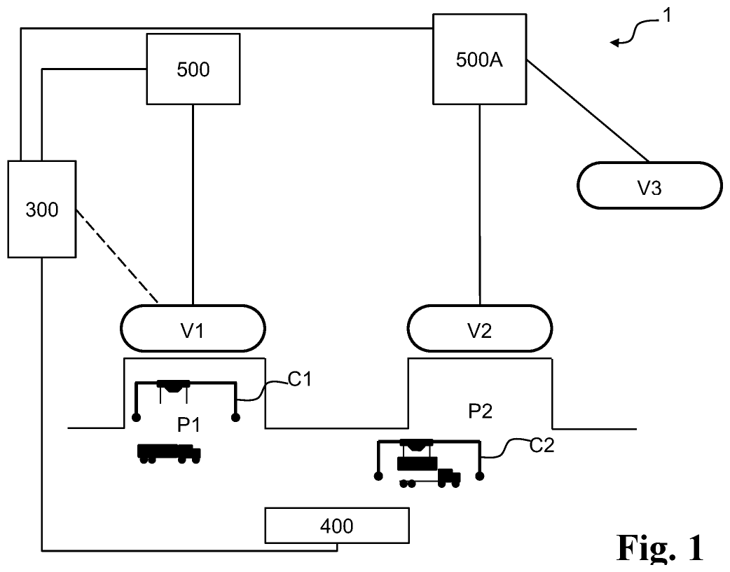

FIG. 1 is a diagram illustrating an exemplary system 1 according to this disclosure.

As discussed in detail herein, the present disclosure relates to a system 1 comprising an electronic device 300 and/or a terminal control system 400 and/or a carrier control system 500, 500A.

A terminal control system 400 disclosed herein refers to a system configured to control, schedule and/or manage equipment associated with the terminal, such as one or more of: one or more cranes, one or more quay cranes, and other terminal equipment.

The carrier control system 500 is configured to communicate and/or control one or more vessels, such as vessel V1. The carrier control system 500A is configured to communicate and/or control one or more vessels, such as vessel V2, V3.

An electronic device 300 may refer to an electronic device configured to perform the method disclosed herein.

The electronic device 300 may be configured to communicate with the terminal control system 400 via a wireless link (and/or a wired link).

The electronic device 300 may be configured to communicate with the carrier control system 500, 500A via a wireless link (and/or a wired link).

FIG. 1 illustrates a terminal comprising a first pier P1 and a second pier P2. In the illustrated example, vessel V1 is located at P1 where crane C1 operates and vessel V2 is located at P2 where crane C2 operates. A equipment in a terminal may comprise one or more cranes, and one or more transport equipment.

A terminal comprises one or more piers and one or more cranes. A pier comprises a plurality of bollards, used as a space unit and as a coordinate system. For example, in Algeciras, an average space of 30 meters separates each bollard. A pier p is characterized by pier parameters such as one or more of: PstartB which represents the first bollard b which represents the starting point of the pier p, and Pend which represents the last bollard b which represents the ending point of the pier p.

Cranes are moving along a rail, parallel to the pier, and share the pier (e.g. the same rail on the pier). Cranes can move on a dedicated area along the rail. For example, a crane can only reach a vessel if it is moored inside its dedicated area. Each crane c is characterized by pier parameters such as one or more of: CstartB, which represents the bollard b which determines the lower moving limit on its rail, CendB which represents the bollard b which determines the upper moving limit on its rail, and CGMPH which represents a crane productivity, such as a gross number of moves (GMPH) realised per hour.

A vessel v may be characterized by one or more identification attributes, such as a vessel code (Vcode), a vessel name (Vname), a length of a vessel (e.g. in meters, Vlength), a maximum speed (e.g. in knots, VmaxSpeed), minimum speed (e.g. knots, VminSpeed), a maximum number of quay cranes that can simultaneously process a vessel (VmaxCranes).

A vessel makes a plurality of voyages. A specific voyage for a vessel v may be characterized by one or more voyage attributes, such as one or more of: a code indicative of the departure of the voyage, a code indicative of the arrival of the voyage, a code indicative of the service of the vessel, the port which is currently calling (VportName), a code used to identify the calling port, an indicator of the previous port (VprevPort, e.g. an indicator of starting point of its current voyage), and an indicator of the next port (VnextPort, e.g. an indicator of the next destination after calling).

Finally, each voyage is linked to specific data, such as one or more of: a distance from the previous port to the current calling port (e.g. a proforma distance from VprevPort to VportName (VdistFromPrevPort)), a distance between the current calling port and the next port (e.g. a proforma distance from VportName to VnextPort (VdistToNextPort)), a bunker cost from the previous port and the current calling port (e.g. a proforma bunker cost from VprevPort to VportName (VprofPrevBC)), a bunker cost from the current calling port and the next port (e.g. a proforma bunker cost from VportName to VnextPort (VprofNextBC)), an actual bunker cost from VprevPort to VportName (VactPrevBC), an actual bunker cost from VportName to VnextPort (VactNextC), a proforma arrival time in the calling port (Vpta), a proforma departure time in the calling port (Vptd), an actual arrival time in the calling port (Vata), an actual departure time in the calling port (Vatd), a proforma time of departure from its previous port (VprevPort-ptd), a proforma time of arrival for its next port (VnextPort-pta), and a proforma Berth position identified by a specific bollard (VprofB), a proforma distance to cover from its previous port to current one (VremainingDistFromPrevPort), a proforma amount of moves to perform (VprofMoves), a vessel speed (Vspeed), a vessel maximum speed (VmaxSpeed, e.g. Vspeed is less or equal to VmaxSpeed), a vessel minimum speed (VminSpeed, e.g. Vspeed is larger or equal to VminSpeed).

Proforma parameters may be seen as estimated parameters, e.g. which may be different from the actual parameters.

A transshipment may refer to the action of unloading container(s) from a vessel vA and reload this same shipment on another vessel vB. To do so, a certain amount of time is required between the arrival time of vessel vA and departure time of vessel vB. This required time varies from 1 to 12 hours and is specific to each connection. In practice, vA provides containers to several vB. A connection co can be realised when:

v_{timeOfArrival}^{B}≥co_{requiredTime}+v_{timeOfDeparture}^{A} (1)

The following notations are introduced to describe a connection co provided by the misconnection re-planning tool with exemplary parameters, such as: a number of boxes to transfer (conbrBoxes), a type of box to transfer (reefer/dry, cotype), a buffer time to succeed the connection (co_{requiredTime}), an identification field (co_id), information about the vessel dropping containers (co_vA), information about the vessel picking up containers (co_vB),

In one or more example embodiments, a decision variable may comprise a boolean to indicate if a connection co is a success or not (co_succeed). For example, corequiredTime=AT where AT is set to 8 hours, e.g. to simplify technical considerations. The present disclosure supports more complex rules for the connection.

Each vessel v in the set V may be assigned to a Berth position vb from its arrival time vTA to its departure time vTD. The Berth position is represented by a bollard b of a set B. The vessel arrival and departure times belong to T. Each bollard belongs to a pier p of a pier set P. Crane c of crane set C may be assigned to a vessel to process it. It may be assumed that vessels in the set V have to be processed by cranes during their service time.

The Berth plan disclosed herein is optimized based on one or more vessel criteria (such as vessels' delays regarding proforma arrival time, vessels' delay regarding earliest arrival time, vessel's bunker cost, missed connection and crane utilization). In other words, in case of a disruption with the existing proforma Berth plan arises (e.g. a vessel is delayed), the present disclosure obtains input data (e.g. information on the cause of disruption (e.g. the vessel position, remaining distance to the terminal, cargo connecting at the terminal), current Berth plan indicating the existing Berth plan and master data, such as crane availability, pier setup) and applies the optimization (such as based on Adaptive Large Neighborhood Search (ALNS)) which considers not only a single objective but multiple ones, such as bunker costs, penalty for missed connections and terminal efficiency. The optimization disclosed herein provides multiple optimized Berth plans, solving the disruption at hand. The carrier control system and terminal control system are informed and may be capable of executing operations without the need of time-consuming re-optimizations and adjustments.

A Berth plan may comprise a vessel v to process at time t for crane c, where c_v,t is 0 (when the vessel v is not processed by crane c at time t) or 1 (when the vessel v is processed by crane c at time t), arrival time of the vessel, departure time of the vessel, a Berth position of the vessel identified by a specific bollard b.

In one or more example embodiments, a vessel v cannot arrive in its calling port before its proforma previous port time of departure.

In one or more example embodiments, a vessel v cannot arrive in its calling port before its earliest time of arrival.

In one or more example embodiments, a vessel v cannot exceed its maximum speed or move slower than its minimum speed. In one or more example embodiments, a vessel v can be late in its next port. In one or more example embodiments, a vessel v cannot change its Berth position once it is berthed. In one or more example embodiments, a vessel v can Berth over a discrete number of bollard positions. In one or more example embodiments, a vessel v can Berth each hour. In one or more example embodiments, a vessel v cannot be processed simultaneously by more than vmaxCranes cranes. In one or more example embodiments, crew resting time is not considered. It may happen in real case when vessel has been moored in front of a terminal These may be seen as rules to apply for vessels.

In a terminal, the following rules may be applied. In one or more example embodiments, a terminal has a fix amount of resources to process all vessels in V for the all horizon time T, which are defined by C, B, P. In one or more example embodiments, berthing time and starting time are equal: time to enter the port, maneuver and Berth is not considered. In one or more example embodiments, pilots are not required to Berth vessels. In one or more example embodiments, no fixed priorities between vessels exist. In one or more example embodiments, workforce cost (crane, bollard, etc.) is fixed and equal regarding night, day, weekday or weekend hours. In one or more example embodiments, the length of the longest pier is longer than the length of any vessel to process. In one or more example embodiments, a container position is unknown, and each loading or unloading of container represents the same operation (a move). In one or more example embodiments, no delay can occur on a vessel while it's already berthed. In one or more example embodiments, draft is not considered when a terminal's depth is big enough. In one or more example embodiments, tilde window is not considered.

Regarding a crane c, rules may be applied. In one or more example embodiments, a crane productivity is fixed to e.g. 30 gross move per hours, or less than 30 gross move per hours, e.g. 28 gross move per hours or less than 28 gross move per hours, e.g. 25 or less than 25 gross move per hours. In one or more example embodiments, maintenance on cranes is not considered and no crane failure occurs. In one or more example embodiments, a crane set up is not required to start processing a vessel. In one or more example embodiments, no time is needed to move a crane from one position to another one. In one or more example embodiments, cranes cannot work beyond their space limits: cranes cannot process a vessel if the vessel is not berthed.

In one or more example embodiments, cranes can overtake other cranes on the rail. In one or more example embodiments, cranes cannot process two vessels at the same time. In one or more example embodiments, each crane is hourly engaged. In one or more example embodiments, a crane is always assigned to a position.

Global network rules may be applied. In one or more example embodiments, vessels are not allowed to skip the calling terminal. In one or more example embodiments, vessels need to Berth and be processed in their calling port during the time of horizon. In one or more example embodiments, time of horizon is big enough to process all vessels. In one or more example embodiments, a customer impact is not considered even on a long time period (It can be impacted regarding recurrent missed connections or delays).

A vessel v is ready to be processed when all of the moves can be realized, e.g.: enough cranes are assigned on the vessel for enough time to perform all required operations (load and unload containers).

VtoProcess is set to true if Equation 2 is respected. vserviceTime is defined by e.g. equation 3:

$${v}_{serviceTime} \geq \frac{{\sum }_{c ∈ 𝒞} {c}_{v , t} * {c}_{GMPH}}{{v}_{profMoves}} \qquad ( 2 )$$

where c_{GMPH} is a crane productivity of crane c, (e.g. 30 gross move per hours, or less than 30 gross move per hours).

v_{serviceTime}=v_{TD}−v_{TA} (3)

During optimization process, when t<vTA (a vessel did not arrive yet): either the vessel is already well scheduled vtoprocess=false or it needs to be rescheduled (e.g.: due to ETA changes) and VtoProcess=true. Even if vtoprocess=false, the vessel can still be rescheduled to improve the solution. In both cases, vessel is not berthed: cranes do not start to work on it and no move is performed: Vprocess=false. When t=vTA operations on v start. In that case, it is forbidden to reschedule the vessel and vprocess is set to true and vtoproCess=false.

Based on the architecture of the terminal (e.g. length of the pier, depth) and vessels' properties, bollards cannot host all vessels. All available potential Berth positions may be computed during a preprocessing phase for each vessel. An available bollard may only require having a sufficient available length to host the vessel. A bollard bstart is an available Berth position for vessel.

∀i ∈ {bₛₜₐᵣₜ; . . . ; bₛₜₐᵣₜ₊ᵥ_{_{lenghtInBollard}}} b_{start_pier}=b_{i_pier} (4)

Earliest time of arrival VearliestTA denotes the earliest time for vessel v to be processed in a terminal. Earliest time of arrival can be before or after the proforma arrival time. Earliest time of arrival may be the highest value of these three constraints:
v did not leave its previous port, and can arrive at (Vnextport_pta+1) at the earliest,
v has a maximum speed limit and needs at least DeltaT=v_{remainingDistToPort}/v_{maxSpeed} hours to arrive.
generated estimated time of arrival ETA changes impact the earliest arrival in the terminal. A vessel bunker cost may be based on the sum of the bunker cost due to the voyage from the last port to the currently called (e.g. previous bunker cost) and the bunker cost from the currently called port to the next one (e.g. next bunker cost). For example, the vessel bunker cost may be the result of adding the previous bunker cost and the next bunker cost.

For example, as long as the vessel sails, distance to the port decreases. For example, the remaining distance to do during the voyage equals to VdistFromPrevPort when the vessel leaves the previous port and equals to zero when the vessel arrives in its calling port. It may be assumed that the pace of the vessel is stable until its arrival time is changed. For example, the previous bunker cost may be based on the remaining distance, the vessel speed, and the current TA at time t and the bunker prices. When a new estimated time of arrival is decided at t′, remaining distance and bunker cost may evolve in the following way e.g.:

$${v}_{remainingDistFromPrevPort , {t}^{′}} = {v}_{remainingDistFromPrevPort , t} * \frac{( {t}^{′} - t )}{{v}_{TA , t} - t}$$

$${v}_{speed , {t}^{′}} = Max ( \frac{{v}_{remainingDistFromPrevPort , {t}^{′}}}{( {v}_{TA , {t}^{′}} - {t}^{′} )} , {v}_{maxSpeed} )$$

$${v}_{prevBC} = {v}_{prevBC} + ( F ( {v}_{speed , t} ) * ( {t}^{′} - t ) * BunkerPrice )$$

wherein vprevBC denotes the previous bunker cost.

Next bunker cost may be calculated e.g.:

$${v}_{nextBC} = F ( {v}_{speed} ) * ( {v}_{nextPort \_ pta} - {v}_{TD} ) * BunkerPrice )$$

$${v}_{speed} = \frac{{v}_{distToNextPort}}{( {v}_{nextPort \_ pta} - {v}_{TD} )}$$

For the next bunker cost, it may be assumed that no remaining distance exists as the voyage has not started.

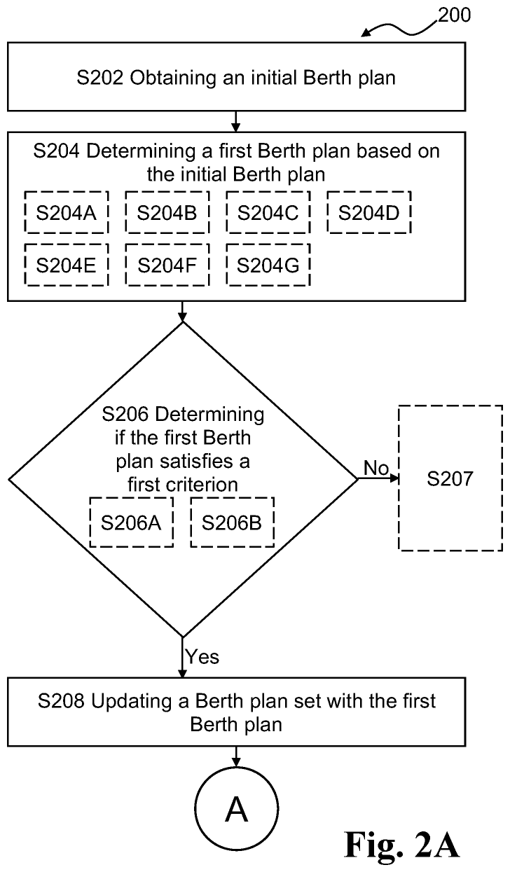

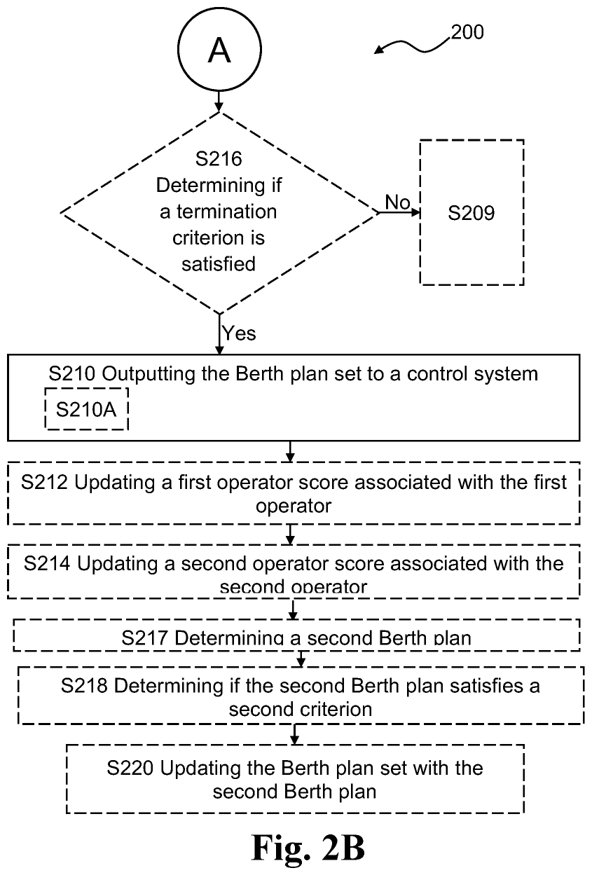

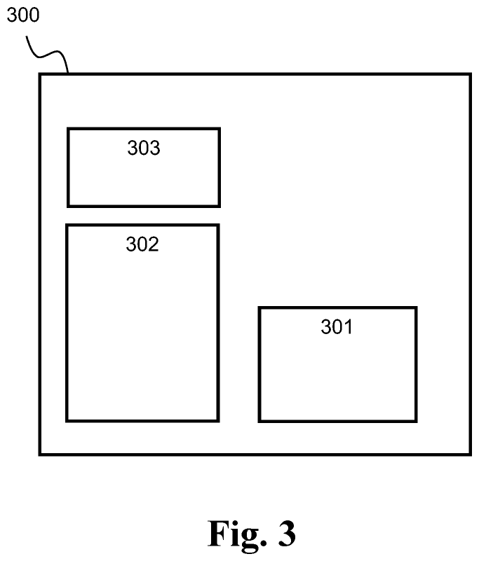

FIGS. 2A-B show a flow diagram of an exemplary method 200 of handling one or more vessels and/or equipment in a terminal according to the disclosure. The method is performed by an electronic device, such as electronic device 300 of FIG. 3.

The method 200 comprises obtaining S202 an initial Berth plan comprising vessel data of a set of vessels. For example, using last updates on vessels, terminal asset and other vessels' schedules, an initial Berth plan can be created. An initial Berth plan may comprise a previous Berth plan, and/or a randomly selected Berth plan, and/or a proforma Berth plan, and/or a default initial Berth plan. For example, vessel data may comprise one or more attributes associated with a corresponding vessel, such as an estimated time of arrival, an estimated time of departure, an information of its Berth position given by the identification of a bollard. For example, the Berth position may define where the vessel is to be moored on the quay. A Berth plan may comprise a vessel information regarding its quay crane assignment. Its quay crane assignment ensures enough quay cranes are available to unload and/or load containers (discharge and load containers) between the estimated time of arrival and departure of a vessel.

For example, vessel data may comprise one or more identification attributes, and/or one or more voyage data associated with a corresponding vessel. A vessel v may be characterized by one or more identification attributes, such as a vessel code (Vcode), a vessel name (Vname), a length of a vessel (e.g. in meters, Vlength), a maximum speed (e.g. in knots, VmaxSpeed), minimum speed (e.g. knots, VminSpeed), a maximum number of quay cranes that can simultaneously process a vessel (VmaxCranes).

The method 200 comprises determining S204 a first Berth plan based on the initial Berth plan. In one or more example methods, determining S204 the first Berth plan comprises updating S204A vessel data of the initial Berth plan by performing adaptive large neighbourhood search (ALNS) on the initial Berth plan. For example, determining S204 the first Berth plan comprises updating S204A vessel data of the initial Berth plan by performing a Weighted Objectives Method to lead to a single plan in which carriers and terminals have pre-agreed on the relevance of the objectives.

In one or more example methods, determining S204 the first Berth plan comprises applying S204B a first operator to the initial Berth plan to select a number of vessels in the initial Berth plan based on a first score. For example, a first operate may comprise a destroy operator. For example, a first operator is applied to the initial Berth plan to reduce a number of vessels and/or create a subset of vessels. For example, if vessels are removed too many times, the removal may postpone their arrival time. For instance, if a vessel v is selected whereas the vessel v has no delay, it is not possible to reschedule v sooner. When assignments are created, proposed time slots are VearliestTA, VearliestTA+3), (VearliestTA+6), (vearliestTA+9), etc. For example, v has more chances to be delayed: it may lead to poorer results. So when the number of remaining vessels to process becomes smaller and smaller, restrictions need to be taken. For example, the number of vessels to remove may be limited when the vessels are fewer than an upper bound, e.g. 12.

For example, one or more vessels (e.g. phi vessels) from the initial Berth plan are removed using a destroy operator. Several destroy operators may be available. In one or more example methods, determining S204 the first Berth plan comprises selecting S204C the first operator from a set of first operators. For example, the first operator is a destroy operator. For example, a set of first operators may be an ordered list based on first operators scores of respective first operators Selection of first operators may be dynamically managed. At each iteration, the first operator is rewarded based on its ability e.g. to provide a good solution. Each first operator uses a specific technique to remove vessels (focus on vessels with the same Berthing area, focus on vessels with the same time window, focus on vessels with same Berthing area and time window or randomly removed vessels.). For example, performing adaptive large neighbourhood search (ALNS) on the initial Berth plan comprises generating the earliest arrival time of all vessels in the set V (e.g. regarding speed, distance to the called port, potential delay). For example, for all vessels, several possibilities to fit in the Berth plan are generated (e.g. each possibility ensures a feasible and free time window, feasible and free Berth position and free enough reachable cranes regarding the Berth position to discharge and load containers during the time window).

For example, the first operator may comprise a “Cost and time destroy operator” which operates as follows. First the Cost and time destroy operator sorts vessels by increasing a first score. The first score may be a relative performance comparing vessel connection and delay, regarding other vessels. For example, the Cost and time destroy operator selects and removes the vessel with the highest score (worst one) from the plan. Afterwards, the Cost and time destroy operator randomly removes all of its time-related vessels (until phi vessels are removed in total). By definition, two vessels are time-related if they are berthed at the same time. Finally, if less than phi vessels have been removed, the process is repeated with the vessel having the second highest score, and so one.

For example, the first operator may comprise a “Cost and Berth destroy operator” which operates as the previous operator but, it removes the Berth-related vessels. By definition, two vessels are Berth-related if they are berthed at the same Berth position.

For example, the first operator may comprise a “Random removal operator” which randomly selects and removes a vessel from the plan as a first step. Then, until phi vessels are removed, “Random removal operator” randomly selects a new vessel in the plan. If both of them are time-related, vessel is automatically removed. Otherwise, a random number p ∈[0; 1] is generated and a vessel is removed if p is larger than a deterministic factor in range [0.6, 1].

For example, the first operator may comprise “Shaw removal operator” which works as follows: first, the “Shaw removal operator” randomly selects and removes a vessel from the plan. Then, the “Shaw removal operator” calculates a relatedness measure with all other non-removed vessels. Equation 10 gives the relatedness measure between two vessels v and v′. Used parameters values are (a,b,c)=(0.01, 2.0, 0.01). If vessels are on different piers, a=0. These relatedness values are computed and ranked by increasing order. A deterministic factor Pshaw Removal Destroy in range [0.6; 1] is then randomly generated. Vessel corresponding to the first relatedness value is removed if p in range [0; 1] is less or equal to PshawRemovalDestroy. If not, vessel corresponding to the second relatedness values is removed, and so on. Operations are repeated until the number of vessels is removed.

relatedness(v,v′)=a|v_{b}−v′_{b}|+b|v_{TA}−v′_{TA}|+c|v_{TD}−V′_{TD}| (10)

In one or more example methods, determining S204 the first Berth plan comprises applying S204D a second operator to the selected number of vessels to update vessel data of the selected number of vessels, e.g. to determine the first Berth plan. For example, the second operator comprises a repair operator. For example, applying S204D a second operator to the selected number of vessels comprises re-inserting one or more vessels in a Berth plan using the second operator and the generated possibilities. In one or more example methods, determining S204 the first Berth plan comprises providing S204E the first Berth plan based on the updated vessel data of the selected number of vessels. In one or more example methods, determining S204 the first Berth plan comprises selecting S204F the second operator from a set of second operators. For example, the second operator is a repair operator. For example, a set of second operators may be an ordered list based on second operators scores of respective second operators. Several second operator are available. Selection of second operator may be dynamically managed. For example, at each iteration, the second operator is rewarded based on its ability to provide satisfactory solutions. For example, each second operator uses a specific technique to insert vessels (such as, focus on vessels bunker costs, focus on vessels connections, focus on earliest arrival, and/or randomly inserting vessels in the Berth plan) and a first Berth plan is provided.

A repair operator inserts the number of removed vessels in the plan. The second operators may be based on a linear cost of delay and crane utilisation.

For example, the second operator may comprise a “Bunker cost repair operator” which inserts vessels one after the other starting from the one with the earliest to the latest proforma arrival time. When a vessel to insert is picked, its assignments are generated and ranked by increasing a second score (e.g. a bunker cost score). For the all process, a deterministic factor p in range [0.25; 1] is generated. After that, a random number p of [0; 1] is generated. If p<PbcRepair, first assignment is selected. Otherwise, p is re-generated to select the next assignment in the list, until p<PbcRepair—Then, the second operator tries to insert the vessel using values of the selected assignment. If , the second operator failed, all remaining assignments are successively tested. If no assignment fits in, an extended generation of assignments is computed and the operator repeats the process. Finally, if still no feasible time slot is found, vessel is inserted using the method Static-QS.

For example, the second operator may comprise a “Connection cost repair operator” which works similarly as the “Bunker cost repair operator” but ranks each removed vessel by increasing a score, e.g. the second score. For example, when the second operator (e.g. a repair operator) inserts a vessel in the Berth plan, it can choose between several assignment. For example, each assignment can be related to a specif score e.g.: a missed connection score, a bunker cost score, a delay score (e.g. scmc, scbc, scdelay).

In one or more example embodiments, a list of assignments for a vessel v is generated when a repair operator is used. An assignment may be seen as a selection of solutions for each vessel, so the repair operator does not need to try all possibilities. Each assignment has for example one or more of the following attributes:
start Time: means that vTA=start Time,
service Time: time spent berthed (from startTime to startTime+service Time),
firstBollard: means vb=firstBollard,
missed connection score sc_{mc}: a missed connection values of the vessel,
bunker cost score sc_{bc}: a bunker cost value for the all voyage,
delay score sc_{delay}: an estimated delay of the vessel.

To reduce computational time and increase efficiency, assignments may be created only if they ensure berth position firstbollard is free from startTime to (startTime+serviceTime) and enough quay cranes are available to process the vessel during this time period. Assignments can be generated for each startTime at all hours t and for each bollard b. For example, assignments can be generated in a time window of 24 hours, spaced out from 3 hours each (e.g. assuming a vessel cannot berthed at start Time, the vessel has more chance to succeed at startTime+2 rather than startTime+1). Also, a maximum delay of an assignment may be limited to 24 hours otherwise it promotes a poor behaviour. This approach may be faster to compute but may reduce the number of choices and can lead to no feasible solution after trying all generated assignments. In case, this unfortunate situation happens, the generation of assignments may be extended to a time window of 72 hours, spaced out from 1 hour each.

For example, the second operator may comprise a “First arrival repair operator” which works similarly as the “Bunker cost repair operator” but ranks each removed vessel by increasing delay score based on startTime and VearliestTA.

For example, the second operator may comprise a “Random repair operator” which works similarly as the “Bunker cost repair operator”, however, assignments aren't ranked and are randomly chosen.

For example, each operator has a probability Wi to be chosen, e.g. randomly chosen and in range [0;1] Each operator i may be defined by:
phi_i, number of uses over the last x iterations, phi_i=0 at the beginning,
Wi, a weight. wt=0 at t=0 and is updated at each iteration as follows:
Wi=(1−η)*Wi+Wi*η/phi_i where is a reaction factor to make the weight evolve in a steady manner
if phi_i=0 , Wi does not change

For example, a score may be updated at each iteration.
a probability to be chosen, equal to wi/sum(wi) over the number of operators.

For example, x=1000, η=0.8.

The method 200 comprises determining S206 if the first Berth plan satisfies a first criterion. In one or more example methods, determining S206 if the first Berth plan satisfies the first criterion comprises determining S206A a first performance parameter of a set of performance parameters based on the first Berth plan.

In one or more example methods, determining S206 if the first Berth plan satisfies the first criterion comprises determining S206B if the first performance parameter satisfies the first criterion. In one or more example methods, the set of performance parameters is indicative of terminal performance and/or carrier performance of a carrier using the terminal. In one or more example methods, the method 200 comprises in accordance with the first performance parameter satisfies the first criterion, updating S208 a Berth plan set with the first Berth plan. In one or more example methods, the method 200 comprises in accordance with the first performance parameter does not satisfy the first criterion, forgoing S207 updating a Berth plan set with the first Berth plan.

In one or more example methods, the set of performance parameters comprises one or more performance parameters indicative of one or more delays, and/or equipment efficiency, and/or missed connections, and/or bunker cost.

In one or more example methods, the first criterion may be based on one or more of: one or more delays, equipment efficiency, missed connections, and bunker cost,

For example, the one or more delays may comprise proforma delay, expressed in hours (cf. Equation 5):

$$ProformaDelay = \frac{{\sum }_{v ∈ V} ( {v}_{TD} - {v}_{ptd} )}{\vert V \vert} \qquad ( 5 )$$

For example, the equipment intensity comprises crane intensity (cf. Equation 6).

$$Crane Intensity = 1 - \frac{{\sum }_{v ∈ V} \frac{{\sum }_{t = TA}^{TD} ( \frac{{v}_{usedCranes \_ t}}{{v}_{maxCranes}} )}{{v}_{TD} - {v}_{TA}}}{{\sum }_{v ∈ V} {v}_{TD} - {v}_{TA}} \qquad ( 6 )$$

For example, missed connections may be expressed in % e.g. by Equation 7

$$Missed Connections = \frac{{\sum }_{v ∈ V} ( {\sum }_{co ∈ {v}_{co}} {co}_{succeed} * {co}_{nbrBoxes} )}{{\sum }_{v ∈ V} ( {\sum }_{co ∈ {v}_{co}} {co}_{nbrBoxes} )} \qquad ( 7 )$$

For example, bunker cost may be expressed by currency (e.g. dollars) e.g. equation 8:

BunkerCost=Σ_{v∈V}(v_{nextBC}+v_{prevBC}) (8)

For example, the one or more delays may comprise earliest arrival delay e.g.:

$$Earliest Arrival Delay = \frac{{\sum }_{v ∈ V} ( {v}_{TA} - {v}_{earliestTA} )}{\vert V \vert} \qquad ( 9 )$$

In an example, let C be a set of criteria to minimize where C comprises the proforma delay, the earliest arrival delay, the bunker cost, the crane intensity, and the missed connections.

fc(s) denotes the best value of criteria c of a feasible solution s in a pool S. By definition, a solution s1 is dominated by s2 in the Pareto manner if e.g.:

1. for any c of C, fc(s1)<fc(s2)

2. there exists a c of C s.t. fc(s1)<fc(s2)

The method 200 comprises in accordance with a determination that the first Berth plan satisfies the first criterion, updating S208 a Berth plan set with the first Berth plan.

For example, the first Berth plan is then assessed on various KPI represented by criteria c of C based on the first performance parameters (e.g. vessels schedules, quay crane assignments, vessels bunker costs and missed connection).

For example, the first Berth plan is then tested and compared to the previous results. If the first Berth plan approaches the pareto front step by step of a non-dominated pool of solutions, the first Berth plan is added to the Berth plan set.

The method 200 comprises in accordance with a determination that the first Berth plan does not satisfy the first criterion, forgoing S207 updating a Berth plan set with the first Berth plan.

The method 200 comprises outputting S210 the Berth plan set to a control system (e.g. to a terminal control system and/or a carrier control system and/or a vessel).

The disclosed method proposes a diversified Berth plan set with several operators and an improved Berth plan set thanks to dynamic operator choice management. The Pareto front provides different scenarios to the user and doesn't require to weigh objectives or to use a constrained method. Moreover, the disclosed method can be easily customized by adding and removing operators or tuning the management of the Pareto front.

The disclosed method enables to quickly observe various ways to optimize the plan using multiple operators. As criteria are highly linked (vessel delay can impact the bunker cost and missed connection, etc.), using the disclosed method with various operators help to find the best sequences of vessels. Using randomness is advantageous to obtain diversified Berth plan. set.

The disclosed method can be seen as solving a multi-objective problem and Pareto front domination in an efficient way to overcome weighted criterion methods and manage diversity and focusing only on the best solutions with the best KPI, which can lead to a suboptimal solution. For example, the disclosed method allows faster reaction times for vessel or terminal disruptions. Several berth plans are provided to the final control system with multiple independent and diversified objectives considered, balancing the carrier and terminal objectives and the pareto front is quickly approached.

With the disclosed method, it is easier to maintain and customise to add any new criterion. the disclosed method allows to add many practical constraints efficiently (draft, tide window, quay crane efficiency) with small impact on the complexity.

In one or more example methods, the method 200 comprises updating S212 a first operator score associated with the first operator. For example, the first operator score is updated (e.g. rewarded) when the first Berth plan is assessed and compared to the set of Berth plan after step S208.

In one or more example methods, the method 200 comprises updating S214 a second operator score associated with the second operator. For example, the second operator score is updated (e.g. rewarded) when the first Berth plan is assessed and compared to the set of Berth plan after step S208.

In other words, the method disclosed herein allows partially destroying and repairing a Berth plan to fill a pool of non-dominated Berth plans.

In one or more example methods, determining S204 the first Berth plan comprises updating S204G vessel data of the initial Berth plan by performing a genetic algorithm technique on the initial Berth plan. For example, the genetic algorithm technique may comprise Non-dominated Sorting Genetic Algorithm technique and/or Multi-objectives Genetic Algorithm technique (e.g.: NSGA-II , MOGA, GA).

In one or more example methods, outputting S210 the Berth plan set to a control system comprises controlling S210A the vessel(s) and/or the equipment based on the Berth plan set.

In one or more example methods, after updating the Berth plan set, determining S216 if a termination criterion is satisfied. In one or more example methods, outputting S210 the Berth plan set to a control system is performed in accordance with a determination that the termination criterion is satisfied. For example, an initial Berth plan s is chosen which is successively improved until the terminal criterion is reached, e.g. until time>maxRunTime. In one or more example methods, forgoing S209 outputting the Berth plan set to a control system is performed in accordance with a determination that the termination criterion is not satisfied.

In one or more example methods, the method 200 comprises determining S217 a second Berth plan.

In one or more example methods, the method 200 comprises determining S218 if the second Berth plan satisfies a second criterion. In one or more embodiments, the second criterion is based on the first criterion, such as the same as the first criterion. In one or more embodiments, the second criterion is different from the first criterion.

In one or more example methods, the method 200 comprises in accordance with a determination that the second Berth plan satisfies the second criterion, updating S220 the Berth plan set with the second Berth plan.

In one or more example methods, the method 200 comprises determining a third Berth plan. In one or more example methods, the method 200 comprises determining if the third Berth plan satisfies the first criterion.

In one or more example methods, the method 200 comprises in accordance with a determination that the third Berth plan satisfies the first criterion, updating the Berth plan set with the third Berth plan.

FIG. 3 shows a block diagram of an exemplary electronic device 300 according to the disclosure. The electronic device 300 comprises a memory circuitry 301, a processor circuitry 302, and an interface 303. The electronic device 300 may be configured to perform any of the methods disclosed in FIGS. 2A-B. In other words, the electronic device 300 may be configured for handling vessels and/or cranes.

The electronic device 300 is configured to communicate with terminal control system and/or a carrier control system.

The interface 303 is configured for wireless communications via a wireless communication system.

The electronic device 300 is configured to obtain, using the processor circuitry 302, an initial Berth plan comprising vessel data of a set of vessels. The method comprises determine, using the processor circuitry 302, a first Berth plan based on the initial Berth plan. The electronic device 300 is configured to determine, using the processor circuitry 302, if the first Berth plan satisfies a first criterion. The electronic device 300 is configured to in accordance with a determination that the first Berth plan satisfies the first criterion, update, using the processor circuitry 302, a Berth plan set with the first Berth plan. The electronic device 300 is configured to output, using the processor circuitry 302 and/or the interface303 the Berth plan set to a control system.

The processor circuitry 302 is optionally configured to perform any of the operations disclosed in FIGS. 2A-B (such as any one or more of S204A, S204B, S204C, S204D, S204E, S204F, S204G, S206A, S206B, S207, S216, S209, S210A, S212, S214, S217, S218, S220). The operations of the electronic device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the electronic device 300 may be considered a method that the electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 3). The memory circuitry 301 is considered a non-transitory computer readable medium.

The memory circuitry 301 may be configured to store the Berth plan set in a part of the memory.

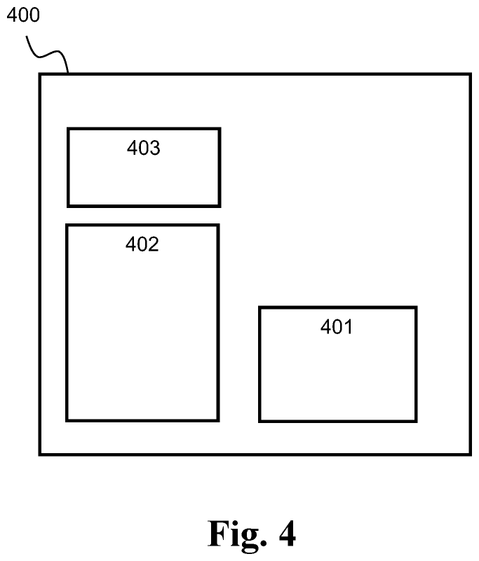

FIG. 4 shows a block diagram illustrating an exemplary terminal control system 400 according to this disclosure.

The terminal control system 400 comprises a memory circuitry 401, a processor circuitry 402, and an interface 403. The terminal control system 400 is configured to receive, via the interface 403, a Berth plan set comprising a plurality of Berth plans. The terminal control system 400 is configured to select, using the processor circuitry 402, a current Berth plan from the Berth plan set; and to control, using the processor circuitry 402, the equipment based on the current Berth plan.

The terminal control system 400 is configured to select a Berth plan as a current Berth plan from the Berth plan set; to determine a current first carrier Berth plan and a current second carrier Berth plan based on the current Berth plan; to transmit the current first Berth plan to a first equipment; and transmit the current second Berth plan to the second equipment.

Furthermore, the operations of the terminal control system 400 may be considered a method that the terminal control system 400 is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 4). The memory circuitry 401 is considered a non-transitory computer readable medium.

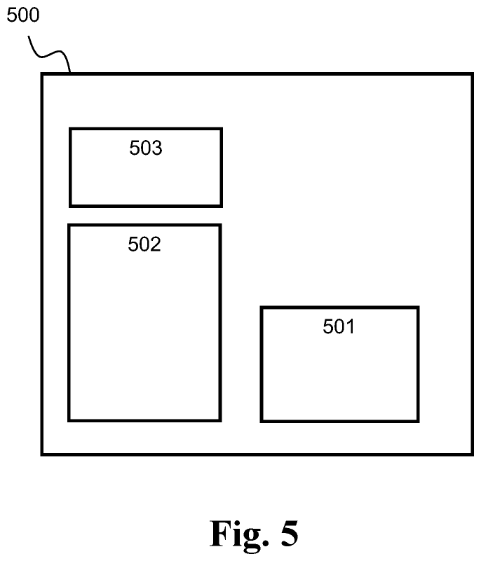

FIG. 5 is a block diagram illustrating an exemplary carrier control system 500 according to this disclosure.

The carrier control system 500 comprises a memory circuitry 501, a processor circuitry 502, and an interface 503.

The carrier control system 500 is configured to receive, e.g. via the interface 503 a current first Berth plan from a terminal control system.

The carrier control system 500 is configured to control, e.g. via the processing circuitry 502 and the interface 503, one or more vessels based on the current first Berth plan.

Furthermore, the operations of the carrier control system 500 may be considered a method that the carrier control system 500 is configured to carry out. Also, while the described functions and operations may be implemented in software, such functionality may as well be carried out via dedicated hardware or firmware, or some combination of hardware, firmware and/or software.

The memory circuitry 501 may be one or more of a buffer, a flash memory, a hard drive, a removable media, a volatile memory, a non-volatile memory, a random access memory (RAM), or other suitable device. In a typical arrangement, the memory circuitry 501 may include a non-volatile memory for long term data storage and a volatile memory that functions as system memory for the processor circuitry 502. The memory circuitry 501 may exchange data with the processor circuitry 502 over a data bus. Control lines and an address bus between the memory circuitry 501 and the processor circuitry 502 also may be present (not shown in FIG. 5). The memory circuitry 501 is considered a non-transitory computer readable medium.

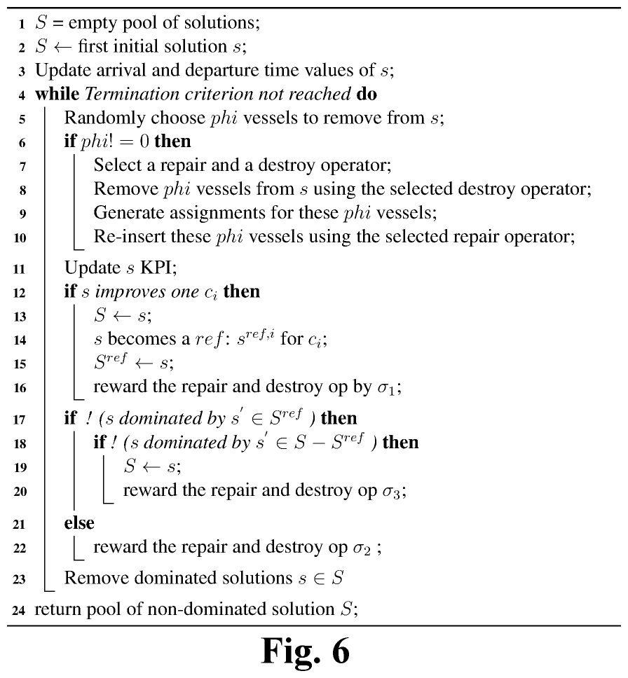

FIG. 6 shows an exemplary method according this disclosure presented as scheme. For example, at each iteration, the disclosed method comprises removing a number of vessel(s), and selecting a repair operator and/or a destroy operator using a uniform law based on operator's weight: the selection of operators is dynamically managed. Destroy operator removes a number of vessel(s) and returns a partial solution (line 8). Repair operator reinserts these number of vessel(s) in the partial solution (line 10). For each removed vessel, pieces of solution, called assignments, are generated (line 9). Each assignment has a berth position, a starting time and ensures its vessel enough available quay cranes at this time. Repair operator uses these assignments to create a new solution. New berth plan is then assessed (line 11) and tested to enter the pool of solutions. Regarding the results of these berth plans, operators are rewarded (lines 16, 20 and 22) to promote their selections for the next iterations and solution is either kept or deleted.

It is then determined whether the obtained Berth plans approach the Pareto front step by step (lines 12, 17 and 18) of a non-dominated pool of berth plans, e.g. the Berth plan set. This enables a faster computational process (lines 12 to 22). Berth plan solution s is the reference regarding criterion ci. In other words, this solution s provides the best result of the pool regarding criterion q.ci

Embodiments of methods and products (electronic device, terminal control system, and carrier control system) according to the disclosure are set out in the following items:

Item 1. A method of handling one or more vessels and/or equipment in a terminal, the method comprising:
obtaining (S202) an initial Berth plan comprising vessel data of a set of vessels;
determining (S204) a first Berth plan based on the initial Berth plan;
determining (S206) if the first Berth plan satisfies a first criterion;
in accordance with a determination that the first Berth plan satisfies the first criterion, updating (S208) a Berth plan set with the first Berth plan; and
outputting (S210) the Berth plan set to a control system.

Item 2. The method according to item 1, wherein determining (S206) if the first Berth plan satisfies the first criterion comprises:
determining (S206A) a first performance parameter of a set of performance parameters based on the first Berth plan; and
determining (S206B) if the first performance parameter satisfies the first criterion.

Item 3. The method according to item 2, wherein the set of performance parameters is indicative of terminal performance and/or carrier performance of a carrier using the terminal.

Item 4. The method according to any of items 2-3, wherein the set of performance parameters comprises one or more performance parameters indicative of one or more delays, and/or equipment efficiency, and/or missed connections, and/or bunker cost.

Item 5. The method according to any of items 1-4, wherein determining (S204) the first Berth plan comprises updating (S204A) vessel data of the initial Berth plan by performing adaptive large neighbourhood search on the initial Berth plan.

Item 6. The method according to any of items 1-5, wherein determining (S204) the first Berth plan comprises applying (S204B) a first operator to the initial Berth plan to select a number of vessels in the initial Berth plan based on a first score.

Item 7. The method according to item 6, wherein determining (S204) the first Berth plan comprises selecting (S204C) the first operator from a set of first operators.

Item 8. The method according to any of items 6-7, the method comprising updating (S212) a first operator score associated with the first operator.

Item 9. The method according to any of items 6-8, wherein determining (S204) the first Berth plan comprises:
applying (S204D) a second operator to the selected number of vessels to update vessel data of the selected number of vessels; and
providing (S204E) the first Berth plan based on the updated vessel data of the selected number of vessels.

Item 10. The method according to item 9, wherein determining (S204) the first Berth plan comprises selecting (S204F) the second operator from a set of second operators.

Item 11. The method according to any of items 9-10, the method comprising updating (S214) a second operator score associated with the second operator.

Item 12. The method according to any of items 1-4, wherein determining (S204) the first Berth plan comprises updating (S204G) vessel data of the initial Berth plan by performing a genetic algorithm technique on the initial Berth plan.

Item 13. The method according to any of items 1-12, wherein outputting (S210) the Berth plan set to a control system comprises controlling (S210A) the vessel(s) and/or the equipment based on the Berth plan set.

Item 14. The method according to any of items 1-13, the method comprising:
after updating the Berth plan set, determining (S216) if a termination criterion is satisfied and wherein outputting (S210) the Berth plan set to a control system is performed in accordance with a determination that the termination criterion is satisfied.

Item 15. The method according to any of items 1-14, the method comprising:
determining (S217) a second Berth plan;
determining (S218) if the second Berth plan satisfies a second criterion; and
in accordance with a determination that the second Berth plan satisfies the second criterion, updating (S220) the Berth plan set with the second Berth plan.

Item 16. An electronic device comprising a memory circuitry, a processor circuitry, and an interface, wherein the electronic device is configured to perform any of the methods according to any of items 1-15.

Item 17. A terminal control system comprising a memory circuitry, a processor circuitry, and an interface, wherein the terminal control system is configured to:
receive a Berth plan set comprising a plurality of Berth plans;
select a current Berth plan from the Berth plan set; and
control the equipment based on the current Berth plan.

Item 18. A carrier control system comprising a memory circuitry, a processor circuitry, and an interface, wherein the carrier control system is configured to:
receive a current first Berth plan from a terminal control system; and
control one or more vessels based on the current first Berth plan.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labeling purposes only and are not intended to denote any specific spatial or temporal ordering. Furthermore, the labeling of a first element does not imply the presence of a second element and vice versa.

It may be appreciated that FIGS. 1-6 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method of handling one or more vessels and/or equipment in a terminal, the method comprising:
obtaining an initial Berth plan comprising vessel data of a set of vessels;
determining a first Berth plan based on the initial Berth plan;
determining if the first Berth plan satisfies a first criterion;
in accordance with a determination that the first Berth plan satisfies the first criterion, updating a Berth plan set with the first Berth plan; and
outputting the Berth plan set to a control system.

2. The method according to claim 1, wherein determining (S206) if the first Berth plan satisfies the first criterion comprises:
determining a first performance parameter of a set of performance parameters based on the first Berth plan; and
determining if the first performance parameter satisfies the first criterion.

3. The method according to claim 2, wherein the set of performance parameters is indicative of terminal performance and/or carrier performance of a carrier using the terminal.

4. The method according to claim 2, wherein the set of performance parameters comprises one or more performance parameters indicative of one or more delays, and/or equipment efficiency, and/or missed connections, and/or bunker cost.

5. The method according to claim 1, wherein determining the first Berth plan comprises updating vessel data of the initial Berth plan by performing adaptive large neighbourhood search on the initial Berth plan.

6. The method according to claim 1, wherein determining the first Berth plan comprises applying a first operator to the initial Berth plan to select a number of vessels in the initial Berth plan based on a first score.

7. The method according to claim 6, wherein determining the first Berth plan comprises selecting the first operator from a set of first operators.

8. The method according to claim 6, the method comprising updating a first operator score associated with the first operator.

9. The method according to claim 6, wherein determining the first Berth plan comprises:
applying a second operator to the selected number of vessels to update vessel data of the selected number of vessels; and
providing the first Berth plan based on the updated vessel data of the selected number of vessels.

10. The method according to claim 9, wherein determining the first Berth plan comprises selecting the second operator from a set of second operators.

11. The method according to claim 9, the method comprising updating a second operator score associated with the second operator.

12. The method according to claim 1, wherein determining the first Berth plan comprises updating vessel data of the initial Berth plan by performing a genetic algorithm technique on the initial Berth plan.

13. The method according to claim 1, wherein outputting the Berth plan set to a control system comprises controlling the vessel(s) and/or the equipment based on the Berth plan set.

14. The method according to claim 1, the method comprising:
after updating the Berth plan set, determining if a termination criterion is satisfied and wherein outputting the Berth plan set to a control system is performed in accordance with a determination that the termination criterion is satisfied.

15. The method according to claim 1, the method comprising:
determining a second Berth plan;
determining if the second Berth plan satisfies a second criterion; and
in accordance with a determination that the second Berth plan satisfies the second criterion, updating the Berth plan set with the second Berth plan.

16. An electronic device comprising a memory circuitry, a processor circuitry, and an interface, wherein the electronic device is configured to perform any of the methods according to claim 1.

17. A terminal control system comprising a memory circuitry, a processor circuitry, and an interface, wherein the terminal control system is configured to:
receive a Berth plan set comprising a plurality of Berth plans;
select a current Berth plan from the Berth plan set; and
control the equipment based on the current Berth plan.

18. A carrier control system comprising a memory circuitry, a processor circuitry, and an interface, wherein the carrier control system is configured to:
receive a current first Berth plan from a terminal control system; and
control one or more vessels based on the current first Berth plan.
